(19) United States
(12) Patent Application Publication
(10) Pub. No.: US 2026/0056575 A1
(43) Pub. Date: Feb. 26, 2026

(54) FOLDABLE INPUT/OUTPUT PORTS

(71) Applicant: Intel Corporation, Santa Clara, CA (US)

(72) Inventors: Jeff KU, Taipei City (TW); Min Suet LIM, Gelugor (MY); Smit KAPILA, Bangalore (IN)

(21) Appl. No.: 19/374,792

(22) Filed: Oct. 30, 2025

(51) Int. Cl. G06F 1/16; H01R 13/512

(52) U.S. Cl. CPC G06F 1/1615; G06F 1/1683; H01R 13/512; H01R 2201/06

(57) ABSTRACT

The disclosure described herein generally relates to a foldable input/output (I/O) port of a computing device, including: a connector board electrically connected to a circuit board of the computing device; one or more I/O connectors arranged on the connector board, wherein the one or more I/O connectors are electrically connected to the connector board and capable of receiving one or more external connectors when the foldable I/O port is in an open configuration; and a housing portion, pivotably connected to the computing device, wherein the housing portion is capable of housing the connector board and the one or more I/O connectors.

### BACKGROUND

With a growing need for higher performance of computers such as laptops, larger fans are employed in the chassis of the computers. Therefore, it is a challenge to balance between the fan size and the placement of other essential hardware components such as the input/output (I/O) ports. Current solutions such as moving the I/O ports in the chassis to accommodate larger fans may leave insufficient space for placing the I/O ports. Consequently, the number of I/O ports that can be offered by the system is limited and the I/O ports may not be placed continuously.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale.

Where considered appropriate, reference labels have been repeated among the figures to indicate corresponding or analogous elements.

FIG. 1A is a schematic diagram illustrating a partial view of a computing device with a foldable input/output (I/O) port in a closed configuration in accordance with an embodiment of the present disclosure.

FIG. 1B is a schematic diagram illustrating a partial view of a computing device with a foldable I/O port in an open configuration in accordance with an embodiment of the present disclosure.

FIG. 1C is an enlarged view of FIG. 1B illustrating the foldable I/O port in an open configuration.

FIG. 2A is a schematic diagram illustrating a front view of a foldable I/O port in an open configuration in accordance with an embodiment of the present disclosure.

FIG. 2B is a schematic diagram illustrating the foldable I/O port of FIG. 2A with several example external connectors plugged into it, in accordance with an embodiment of the present disclosure.

FIG. 3 illustrates an exploded view of a foldable I/O port in accordance with an embodiment of the present disclosure.

FIG. 4A illustrates a side view of a foldable I/O port in a closed configuration in accordance with an embodiment of the present disclosure.

FIG. 4B illustrates a side view of a foldable I/O port in an open configuration in accordance with an embodiment of the present disclosure.

FIG. 5A illustrates a cross-sectional view of a foldable I/O port in a closed configuration in accordance with an embodiment of the present disclosure.

FIG. 5B illustrates a cross-sectional view of a foldable I/O port in an open configuration in accordance with an embodiment of the present disclosure.

FIG. 6 illustrates a cross-sectional view of a computing device with an example placement of a foldable I/O port in a closed configuration in accordance with an embodiment of the present disclosure.

### DETAILED DESCRIPTION

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, electromagnetic radiation). Examples of components that are communicatively coupled include integrated circuit dies located in the same package that communicate via an embedded bridge in a package substrate and an integrated circuit component attached to a printed circuit board that sends signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment”, “various embodiments”, “some embodiments” and the like may include features, structures, or characteristics, but not every embodiment necessarily includes the particular features, structures, or characteristics.

Some embodiments may have some, all, or none of the features described for other embodiments. “First”, “second”, “third” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Optical components such as fibers or waveguides may be “connected” if the gap between them is small enough that light can be transferred from one fiber or waveguide to another fiber or waveguide without any intervening optical elements, such as a lens or mirror. Furthermore, the terms “comprising”, “including”, “having”, and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes and so forth having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth to provide a thorough understanding thereof. It may be evident, however, that the novel embodiments can be practiced without these specific details. In other instances, well-known structures and devices are shown in block diagram form to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second layer or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

With rising demands for System-on-Chip (SoC) performance, power consumption may increase substantially. This necessitates larger fans for thermal dissipation. However, increased fan size may create strict spatial constraints within the chassis. Consequently, to fit a larger fan size for more performance, the area available for essential hardware components may be significantly reduced. For example, a core or middle board, one or more fans, and one or more input/output (I/O) connector boards (or I/O porches) and other components may be arranged on a chassis of a computing device, for instance, a laptop. An I/O port may include an I/O connector board. The I/O port may align with an opening or cutout in the laptop's case (e.g., in a side of the base of the laptop). An I/O connector board (or an I/O porch) may be a small circuit or circuit board in a laptop chassis. The I/O connector board may carry (or bear) one or more input/output (I/O) connectors, for instance, a Universal Serial Bus (USB) receptacle.

Limited by the width of the chassis (or the chassis form factor), the fan size may be restricted by, for example, the width of core size/middle board and the width of the I/O connector board. For example, in a typical design of a laptop, the internal layout of the laptop (or chassis layout) may be constrained along a horizontal axis. The horizontal axis may be defined as being parallel to a hinge line, where the hinge line is the axis of rotation between a lid and a base of the laptop. Along the horizontal axis, several subsystems (including a core or middle board, one or more fans, and one or more I/O connector boards) may compete for the limited planar space on the chassis. These components must be accommodated within the laptop's constraints along the horizontal axis (or the x-constraints), which define the strict lateral boundaries of the chassis and determine the maximum available width for this horizontal lineup of components. Consequently, the area available for hardware components, particularly the I/O ports and the I/O connectors, becomes severely restricted. This conflict between thermal demands (e.g., larger fan size) and physical layout (e.g., limited width of the chassis) presents a fundamental design challenge in advanced computing systems.

The width of the I/O connector board may be limited by the type of connector and the connector's width. For example, a Thunderbolt (TBT) connector that comes with a re-timer placed next to the TBT connector in a Type 3 PCB (Printed Circuit Board) may require a width of 34 mm. For example, a narrow I/O connector board width (less than 25 mm) may require the I/O connector or a re-timer to be staggered or to move forward towards the battery region of the chassis (for example, away from the hinge line of the laptop, or south of the chassis) to accommodate the I/O connector board and the fan.

Various systems in the markets today may face similar challenges to fit I/O ports to accommodate larger fans. In some existing solutions, the I/O ports are moved to accommodate the fans. In a case where the chassis possesses larger fans for 140 W cooling, the side I/O ports are moved forward towards the battery region, causing a narrow board width (less than 15 mm) left not sufficient for placing I/O ports. In another case where the chassis possesses larger fans for 200 W cooling, the side I/O ports are moved forward, causing the I/O ports not to be placed continuously. In another case, where the chassis possesses larger fans for 140 W cooling, the side I/O ports (around 20 mm board width) are moved backward for better user experience and chassis design. However, the fan size and the core area size are affected. Thus, moving the I/O connectors that require larger space on the I/O connector board may limit the number of I/O ports that can be offered by the system. In some other solutions, a costlier Type 4 PCB design may be employed to compact the routing area needed on the I/O connector board and mid/core board. However, this may be a significant cost increase to a mainstream system and not preferred by customers. Therefore, I/O port placement and chassis design are always a challenge for the system design of a computer, for instance, the design of a 14″ high performance laptop. The chassis design herein may include the look of the chassis/computer and the design/location of I/O ports.

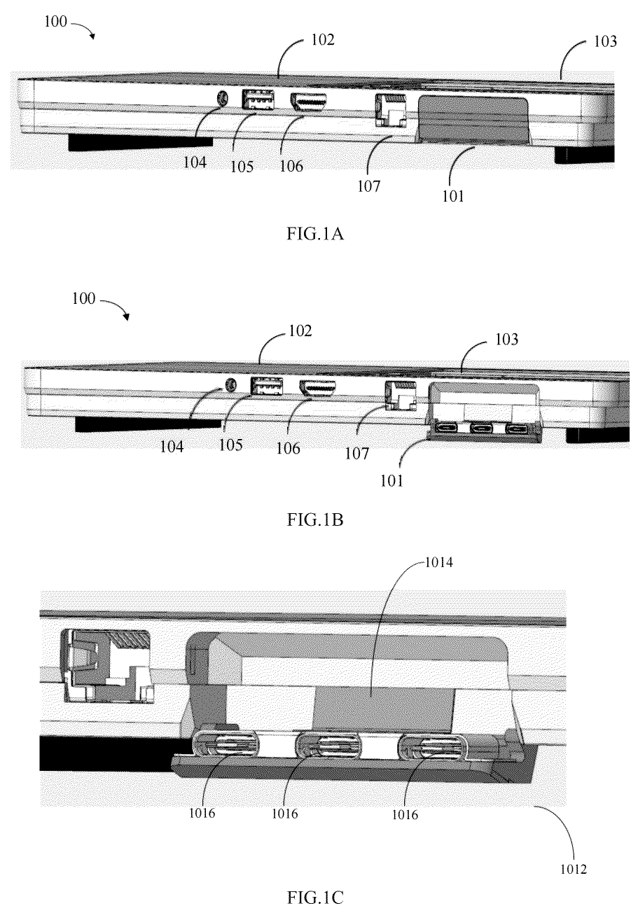

In light of the above challenges, a foldable input/output (I/O) port is provided in accordance with embodiments of the present disclosure. FIG. 1A is a schematic diagram illustrating a partial view of a computing device 100 with a foldable I/O port 101 in a closed configuration in accordance with an embodiment of the present disclosure. FIG. 1B is a schematic diagram illustrating a partial view of a computing device 100 with a foldable I/O port 101 in an open configuration in accordance with an embodiment of the present disclosure. FIG. 1C is an enlarged view of FIG. 1B illustrating the foldable I/O port 101 in an open configuration.

In some examples, a computing device 100 may include a chassis with one or more openings for one or more input/output ports and/or some other suitable devices. In some examples, FIG. 1A and FIG. 1B provide a partial view of the computing device 100. As illustrated in FIG. 1A and FIG. 1B, the computing device 100 may include at least a plurality of I/O ports 101, 104, 105, 106, 107, a chassis 102 and a keyboard 103. The I/O ports 101, 104, 105, 106 and 107 may be any suitable I/O ports for a computing device 100. In an illustrative example, the I/O ports 101, 104, 105, 106, 107 may be located at a side or different sides of the chassis 102.

Among the I/O ports 101, 104, 105, 106 and 107, the I/O port 101 is a foldable I/O port. For example, as illustrated in FIG. 1B, the foldable I/O port 101 may rotate from a closed configuration (or state) as shown in FIG. 1A to an open configuration (or state) as shown in FIG. 1B. Referring to FIG. 1C (the enlarged view of FIG. 1B) focusing on the I/O port 101, the I/O port 101 may include one or more connectors of any type. For example, as illustrated in FIG. 1B and FIG. 1C, the I/O port 101 may include 3 Type C connectors.

In some examples, the computing device 100 may include an audio port 104, a Universal Serial Bus (USB) Type A port 105, a high-definition multimedia interface (HDMI) port 106, an Ethernet port 107. For example, the audio port 104 may be a 3.5-millimeter audio jack. The Ethernet port 107 may be a 2.5 Gigabit Ethernet port.

FIG. 1C is an enlarged view of FIG. 1B illustrating the foldable I/O port 101 in an open configuration. FIG. 1A illustrates a closed configuration of the foldable I/O port 101, while FIG. 1B and FIG. 1C illustrate an open configuration of the foldable I/O port 101. As illustrated in FIG. 1C, the foldable I/O port 101 may include a housing 1012 (or a cover, a lid), a cable 1014 and one or more connectors 1016. In some examples, the foldable I/O port 101 may be pivotably or rotatably attached to the chassis 102.

In some examples, the closed configuration may refer to a situation where the foldable I/O port is folded up inside the computing device 100. The open configuration may refer to a situation where one or more I/O connectors 1016 may be exposed to a user or visible from outside the computing device 100. When the foldable I/O port 101 is pulled down (or rotates downward around an axis like a drawer), the foldable I/O port 101 is in the open configuration. The pivotably opening or closing mechanism of the foldable I/O port 101 is illustrated by way of example, but not by way of limitation. Any suitable mechanism for opening or closing the foldable I/O port 101 may be employed.

The housing 1012 may be pivotably or rotatably attached to the chassis 102 of the computing device 100, allowing the foldable I/O port 101 to swing open and reveal the internal components, for example, one or more connectors 1016. The housing 1012 of the foldable I/O port 101 may be folded back (or folded up) and integrated seamlessly with the exterior of the computing device 100. The housing 1012 may be folded back to form a continuous surface with the exterior of the computing device 100.

In some examples, the foldable I/O port 101 may be electrically coupled, via the cable 1014, to a main board or a circuit board of the computing device 100 or the chassis 102. The cable 1014 may be embodied as any electrical connection component, such as cable(s) or other conductor(s) capable for data signal transmission and/or power transmission. The cable 1014 may be flexible flat cable (FFC), flexible printed circuits (FPC), Flexible Flat Printed Circuits (FFPC), coaxial cables, solid-wire cables, stranded-wire cables, single-conductor cables, ribbon cables, or the like.

It is noted that although described herein with respect to a computing device such as a laptop computer, this is a non-limiting and illustrative application. The electronic device described in further detail herein may be implemented in accordance with any suitable type of device. In some examples, the computing device 100 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a networked computer, a wearable computer, a handset, a messaging device, a camera device, and/or any other computing device. In some embodiments, the computing device 100 may be located in a data center, such as an enterprise data center (e.g., a data center owned and operated by a company and typically located on company premises), a managed services data center (e.g., a data center managed by a third party on behalf of a company), a collocated data center (e.g., a data center in which data center infrastructure is provided by the data center host and a company provides and manages their own data center components (servers, etc.)), cloud data center (e.g., a data center operated by a cloud services provider that host companies” applications and data), and an edge data center (e.g., a data center, typically having a smaller footprint than other data center types, located close to the geographic area that it serves).

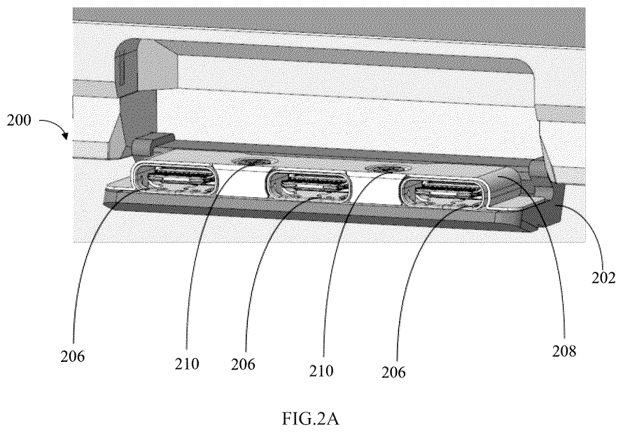

FIG. 2A is a schematic diagram illustrating a front view of a foldable I/O port 200 in an open configuration in accordance with an embodiment of the present disclosure. In some examples, as shown in FIG. 2A, a foldable I/O port 200 may include a housing 202 (or a cover, a lid), a cable 204, one or more connectors 206, a connector housing 208 and one or more screws 210. The screws 210 and the connector housing 208, by way of example, but not by way of limitation, are utilized to create a secure and stable mounting solution for the connectors 206 onto the housing 202. The screws 210 and the connector housing 208 may secure the connectors 206 to the housing 202. The connector housing 208 may contain one or more holes for the screws 210. Each screw 210 may pass through each of these holes and engage with a threaded receptacle in the housing 202.

FIG. 2B is a schematic diagram illustrating several example external connectors 209 plugged into the foldable I/O port 200 in an open configuration in accordance with an embodiment of the present disclosure. When the foldable I/O port 200 is in an open configuration, the connectors 206 are exposed and are ready to receive one or more plugs, for instance, USB-compliant interconnect cables.

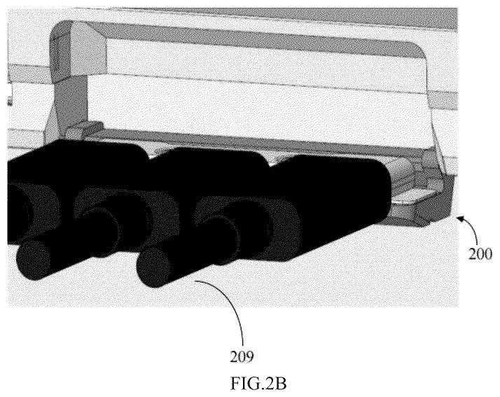

In some examples, referring to FIG. 2B, one or more external connectors 209 may be plugged into the foldable I/O port 200. The external connector 209 may be electrically coupled to the foldable I/O port 200 when plugged into a corresponding connector 206. Data signal transmission and/or power transmission between the external connectors 209 and the foldable I/O port 200 may be enabled when the external connectors 209 and the connectors 206 of the foldable I/O port 200 are mated. FIG. 3 illustrates an exploded view of a foldable I/O port 300 in accordance with an embodiment of the present disclosure.

In some examples, as shown in FIG. 3, a foldable I/O port 300 may include a housing 302 (or an outer drawer housing), a cable 304, a connector board 305, one or more connectors 306 (or I/O connectors), a connector housing 308 and one or more fasteners 310.

The fasteners 310 may be implemented as a plurality of fastening elements, such as screws. In an example as illustrated in FIG. 3, two screws 310 are employed. The screws 310 may fit with two receivers that may be arranged in the housing 302. A fastening mechanism may be formed by the screws 310, the connector housing 308, and the housing 302, by way of example, but not by way of limitation. Such a fastening mechanism (or any other suitable fastening mechanism) may be utilized to create a secure and stable mounting solution for fastening the connectors 306 and the connector board 305 onto the housing 302. Thus, when the housing 302 is folded (up) or pulled (down or out) by, for instance, a user, the connectors 306 and the connector board 305 together with the cable 304 may follow the motion, exposing the connectors 306 ready for plug-in. Other mounting solutions may also be employed in the foldable I/O port 300 in accordance with an embodiment of the present disclosure.

In some examples, as illustrated in FIG. 3, three connectors 306 may be electrically coupled to the connector board 305. The connector board 305 may be electrically coupled to a main board of the computing device (e.g., a laptop) via the cable 304 (e.g., an FPC). For example, the connectors 306 may be connected to the system's main board/mid core board through flex cable 304 to allow flexible placement of the connectors 306. The connector housing 308 may be an outer housing and structural bracket. The connectors 306 may be structurally secured to the housing 302. The housing 302 may be an outer drawer. For example, the housing 302 may be a first housing portion for the foldable I/O port 300. The housing 302 may be used to house the connector board 305, the connectors 306 and the cable 304.

The connector housing 308 may be a second housing portion for the foldable I/O port 300. The connector housing 308 may be used to secure the connectors 306 and the connector board 305 to the housing 302.

In some examples, the connectors 306 can be replaced without opening the complete chassis of the computing device, hence providing a chance to independently replace one or more connectors 306 if any damage occurs. For example, one Type C connector has a damage of >10% in the field. In this case, the configuration of the foldable I/O port 300 may satisfy the need for easy replaceability and may help with modularity of the computing device.

In some examples, the screws 310 and the connector housing 308 may secure the connectors 306 to the housing 302. For example, as illustrated in FIG. 3, the connector housing 308 may contain two holes for the screws 310. The connector board 305 may contain two holes for the screws 310 to pass through. Each screw 310 may sequentially pass through a corresponding hole on the connector housing 308 and a corresponding hole on the connector board 305, and then engage with a threaded receptacle in the housing 302.

In some examples, the screws 310 and the corresponding receptacles may be implemented in any form of fastener mechanism. The fastener mechanism may include a member with external threads (e.g., the screw 310). The specific type of this member is not limited. It can be a screw, a bolt, a threaded stud, or any equivalent. The configuration of its driving head is also not limited. The fastener receptacle is capable of receiving the external threads. The specific form of this receptacle is not limited.

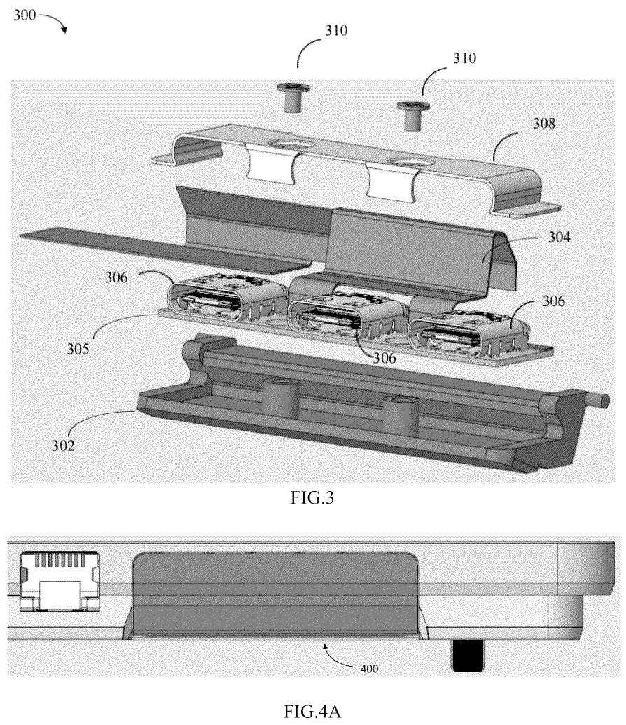

FIG. 4A illustrates a side view of a foldable I/O port 400 in a closed configuration in accordance with an embodiment of the present disclosure. FIG. 4B illustrates a side view of a foldable I/O port 400 in an open configuration in accordance with an embodiment of the present disclosure. FIG. 4A illustrates a side view of a closed configuration of the foldable I/O port 400 at the edge of the chassis, while FIG. 4B illustrates a side view of an open configuration of the foldable I/O port 400 at the edge of the chassis.

The foldable I/O port 400 shown in FIG. 4A and FIG. 4B may be identical or substantially similar in structure and function to the foldable I/O ports 101, 200 and 300 previously described and illustrated in FIG. 1A, FIG. 1B, FIG. 1C, FIG. 2A, FIG. 2B, and FIG. 3. Accordingly, a detailed description of its construction and operation is omitted herein for the sake of brevity. The descriptions, features, and operational principles disclosed in relation to FIGS. 1A-1C, 2A-2B, and 3 are hereby incorporated by reference for the foldable I/O port 400, unless otherwise explicitly stated or context clearly dictates otherwise. Those skilled in the art will readily understand the application of the prior descriptions to the present embodiment.

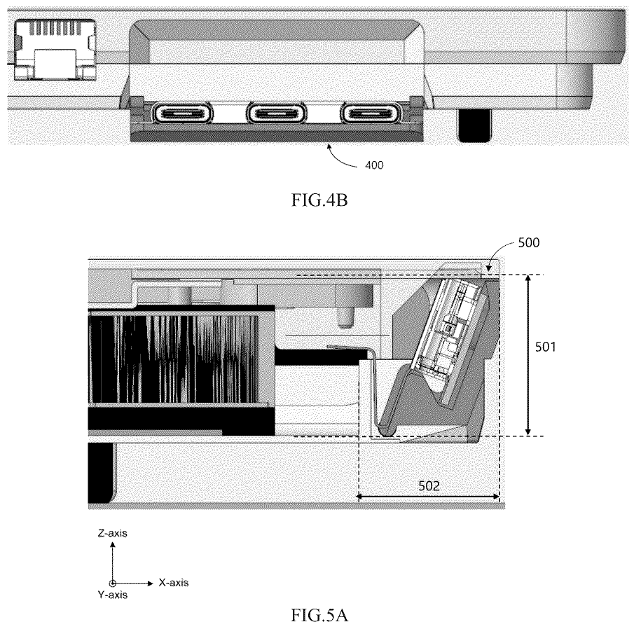

FIG. 5A illustrates a cross-sectional view of a foldable I/O port 500 in a closed configuration in accordance with an embodiment of the present disclosure. The foldable I/O port 500 is disposed in a conventional Cartesian coordinate system as illustrated in FIG. 5A. In such a coordinate system, the foldable I/O port 500 may be rotatable in the (x, z) plane and about the Y axis. The foldable I/O port 500 may be pulled down into an open configuration as illustrated in FIG. 5B. As illustrated in FIG. 5A and FIG. 5B, the foldable I/O port 500 may be arranged on a side of a base of a computing device.

As illustrated in FIG. 5A, the foldable I/O port 500 may be slanted/tilted/diagonally placed, hence the space within the chassis will require less than a horizontal length of a connector. FIG. 5B illustrates a cross-sectional view of a foldable I/O port 500 in an open configuration in accordance with an embodiment of the present disclosure.

As illustrated in FIG. 5A, in some examples, when the foldable I/O port 500 is folded up, the foldable I/O port 500 may form a continuous surface with a surface of the computing device. When the foldable I/O port 500 is folded up, the foldable I/O port 500 is in a closed configuration. The foldable I/O port 500 may be in the closed configuration in response to the foldable I/O port being folded up inside the computing device. The foldable I/O port 500, in a closed configuration, may form a tilted placement inside the computing device relative to the horizontal plane of the chassis. The horizontal plane may be defined by the X axis and the Y axis. In some examples, the foldable I/O port 500, in a closed configuration, may form a vertical placement inside the computing device relative to the horizontal plane of the chassis.

As illustrated in FIG. 5B, the connectors on the foldable I/O port 500 may be placed horizontally. The horizontal length of a connector may be, for instance, about 20 mm. As illustrated in FIG. 5A, in a closed configuration, the width 501 of the foldable I/O port 500 on the X axis may be, for instance, about 11 mm. The height 502 of the foldable I/O port 500 on the Z axis may be, for instance, less than 12 mm. In a closed configuration, I/O connectors in the foldable I/O port 500 can be slanted/tilted/diagonally, hence the height on the Z axis (e.g., height 502) required within the chassis will be less than the length of the I/O connectors.

In some examples, the foldable I/O port 500 may be in an open configuration when the foldable I/O port 500 is pulled down. The cable of the foldable I/O port 500 may be a flexible cable to support a flexible placement of the foldable I/O port 500 inside the computing device. In some examples, at least a portion of the housing 302 (not shown) may bend downwards below the base of the computing device in the open configuration of the foldable I/O port 500. In some examples, at least a portion of the cable may be capable of bending downwards (not shown) below the base of the computing device in the open configuration of the foldable I/O port 500. When the foldable I/O port 500 is pulled down, one or more I/O connectors of the foldable I/O port 500 may be exposed, and the foldable I/O port 500 may support data transmission and/or power transmission between the computing device and the one or more external connectors when the one or more external connectors are plugged into the one or more I/O connectors.

As illustrated and compared in FIG. 5A and FIG. 5B, the pull-down (or pull down like a drawer) mechanism for the foldable I/O port 500 may allow for efficient use of vertical space instead of conventional horizontal placement within the chassis. In some examples, an 11 mm X direction depth is applicable to connectors with a housing Z height less than 6 mm, such as USB-A, HDMI, Audio and USB-C connectors. The Z height herein may refer to the size (height on the Z axis) of the chassis or the computing device (e.g., a laptop) in the Z dimension.

The space occupation may be much less than the commonly used side I/O board width (about 20 mm). The foldable I/O port 500 with Type C connector(s) may be applicable to a system having a base with a Z height less than 15 mm (height of a computing device in Z axis). The foldable I/O port 500 with USB-A/HDMI/Audio jack connector(s) may be applicable to a system having a base with a Z height less than 20 mm.

In some examples, the foldable I/O port 500 may also be called the I/O “drawer” for being like a side “drawer” opened from the chassis (a pull-down mechanism). The foldable I/O port 500 may be added to the space next to the fan to fully utilize the narrow channel without compromises on I/O port count and locations. Such a mechanism may enable the placement of the I/O connector into the narrow I/O connector board width allowing a larger fan design to increase SoC performance.

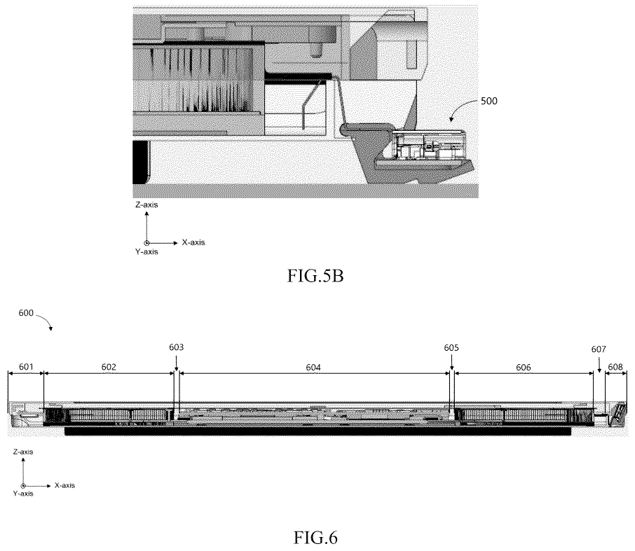

FIG. 6 illustrates a cross-sectional view of a computing device 600 with an example placement of a foldable I/O port 610 in a closed configuration in accordance with an embodiment of the present disclosure. In an example as illustrated in FIG. 6, the foldable I/O port 610 is folded up and is forming a tilted placement.

The foldable I/O port 610, byway of example, but not byway of limitation, is added on the right side of the system. The computing device 600 is disposed in a conventional Cartesian coordinate system as illustrated in FIG. 6. In such a coordinate system, the foldable I/O port 610 may be rotatable in the (x, z) plane and about the Y axis. The Y axis may be facing or facing away from a user who may operate the computer device 600. For example, the computing device 600 may be a laptop. The foldable I/O port 610 may be folded back into the laptop 600's case as illustrated in FIG. 6.

The X dimensions of some components in the chassis of the laptop along the X axis are shown in FIG. 6. Reference number 601 may represent a dimension of a left side wall and a gap of the computing device 600. Reference number 602 may represent a dimension of a fan. Reference number 603 may represent a dimension of a gap. Reference number 604 may represent a dimension of a board core. Reference number 605 may represent a dimension of a gap. Reference number 606 may represent a dimension of a fan. Reference number 607 may represent a dimension of a gap. Reference number 608 may represent a dimension of the foldable I/O port 610. An example of the dimensions (in millimeter) may be as shown in the table 1 below. The gaps herein may include some areas remaining in the system to place in various suitable I/O ports.

TABLE 1
X dimension of components (mm)

| | | |
|---|---|---|
| 601 | a dimension of a left side wall and a gap | 18.5 |
| 602 | a dimension of a fan | 75 |
| 603 | a dimension of a gap | 3 |
| 604 | a dimension of a board core | 155.5 |
| 605 | a dimension of a gap | 3 |
| 606 | a dimension of a fan | 80 |
| 607 | a dimension of a gap | 7 |
| 608 | a dimension of an I/O drawer or a foldable I/O port | 11 |

In some examples, the foldable I/O port 610 may be placed along the Y axis, e.g. near a side where the base and lid of the laptop are connected or join with each other in the chassis of the computing device 600. This may offer a higher number of I/O ports since the foldable I/O port 610 occupies less space. Besides, less space occupation may allow a plurality of connectors to be placed continuously.

As illustrated in FIG. 6, a space occupied by the dimension 607 of a gap and the dimension 608 of the I/O drawer or the foldable I/O port may have a width (in the X dimension) of 18 mm. In some examples, in a scenario (not shown in figures) without the foldable I/O port 610, the space with a width of 18 mm may house a 15.7 mm wide gap and a 2.3 mm wide side wall. In such a situation, the 15.7 mm wide gap is not sufficient to add a commonly used I/O port that requires 20 mm width. In contrast, the foldable I/O port 610 in accordance with the embodiments of the present disclosure may fit into such an 18 mm wide space.

In addition, the foldable I/O port 610 enables a reduction in I/O connector board width and may provide area saving for the computing device 600. The foldable I/O port 610 may fully utilize the narrow space left in the chassis. Thus, the foldable I/O port 610 may enable a larger fan size with no Z impact (that is, the size of the laptop in the Z dimension does not need to be enlarged), such that improved SoC performance may be provided.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), System on-Chip (SoC), desktop computers, laptop computers, tablet computers, servers, smart phones, and so forth.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, and so forth) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a System on Chip (SoC) architecture.

The above detailed description includes references to the accompanying drawings, which form a part of the detailed description. The drawings show, by way of illustration, specific embodiments that may be practiced. These embodiments are also referred to herein as “examples”. Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more”. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first”, “second”, “third” and so forth are used merely as labels, and are not intended to suggest a numerical order for their objects.

Illustrative examples of the technologies disclosed herein are provided below. An embodiment of the technologies may include any one or more, and any combination of, the examples described below.
Example 1 includes a foldable input/output (I/O) port of a computing device, comprising: a connector board electrically connected to a circuit board of the computing device; one or more I/O connectors arranged on the connector board, wherein the one or more I/O connectors are electrically connected with the connector board and capable of receiving one or more external connectors when the foldable I/O port is in an open configuration; and a housing portion, pivotably connected with a chassis of the computing device, wherein the housing portion is capable of housing the connector board and the one or more I/O connectors.
Example 2 includes the subject matter of Example 1, wherein the housing portion is a first housing portion, and the foldable I/O port further comprises: a second housing portion, capable of securing the one or more I/O connectors and the connector board to the first housing portion.
Example 3 includes the subject matter of Example 2, further comprising: one or more fasteners, capable of securing the second housing portion to the first housing portion.
Example 4 includes the subject matter of Example 3, wherein the first housing portion further comprises: one or more receivers, capable of receiving the one or more fasteners.
Example 5 includes the subject matter of Example 1, further capable of: expose the one or more I/O connectors in the open configuration of the foldable I/O port, wherein the foldable I/O port is in the open configuration in response to the foldable I/O port being pulled down.
Example 6 includes the subject matter of Example 1, further capable of: supporting data transmission and/or power transmission between the computing device and the one or more external connectors when the one or more external connectors are plugged into the one or more I/O connectors in the open configuration of the foldable I/O port.
Example 7 includes the subject matter of Example 1, wherein the housing portion is further capable of forming a continuous surface with a surface of the computing device when the foldable I/O port is in a closed configuration, and wherein the foldable I/O port is in the closed configuration in response to the foldable I/O port being folded up inside the computing device.
Example 8 includes the subject matter of Example 7, further capable of forming a tilted placement inside the computing device relative to a horizontal plane of the chassis of the computing device in the closed configuration of the foldable I/O port.
Example 9 includes the subject matter of Example 7, further capable of forming a vertical placement inside the computing device relative to a horizontal plane of the chassis of the computing device in the closed configuration of the foldable I/O port.
Example 10 includes the subject matter of Example 1, further capable of being arranged on a side of a base of the computing device, wherein at least a portion of the housing portion is capable of bending downwards below the base in the open configuration of the foldable I/O port.
Example 11 includes a computing device, comprising: a chassis; and a foldable input/output (I/O) port, wherein the foldable I/O port comprises: a connector board electrically connected to a circuit board of the computing device; one or more I/O connectors arranged on the connector board, wherein the one or more I/O connectors are electrically connected with the connector board and capable of receiving one or more external connectors when the foldable I/O port is in an open configuration; and a housing portion, pivotably connected with the chassis of the computing device, wherein the housing portion is capable of housing the connector board and the one or more I/O connectors.
Example 12 includes the subject matter of Example 11, wherein the housing portion is a first housing portion, and the foldable I/O port further comprises: a second housing portion, capable of securing the one or more I/O connectors and the connector board to the first housing portion.
Example 13 includes the subject matter of Example 12, wherein the foldable I/O port further comprises: one or more fasteners, capable of securing the second housing portion to the first housing portion.
Example 14 includes the subject matter of Example 13, wherein the first housing portion further comprises: one or more receivers, capable of receiving the one or more fasteners.
Example 15 includes the subject matter of Example 11, wherein the foldable I/O port is further capable of: exposing the one or more I/O connectors in the open configuration of the foldable I/O port, wherein the foldable I/O port is in the open configuration in response to the foldable I/O port being pulled down.
Example 16 includes the subject matter of Example 11, wherein the foldable I/O port is further capable of: supporting data transmission and/or power transmission between the computing device and the one or more external connectors when the one or more external connectors are plugged into the one or more I/O connectors in the open configuration of the foldable I/O port.
Example 17 includes the subject matter of Example 11, wherein the housing portion is further capable of forming a continuous surface with a surface of the computing device when the foldable I/O port is in a closed configuration, and wherein the foldable I/O port is in the closed configuration in response to the foldable I/O port being folded up inside the computing device.
Example 18 includes the subject matter of Example 17, wherein the foldable I/O port is further capable of forming a tilted placement inside the computing device relative to a horizontal plane of the chassis in the closed configuration of the foldable I/O port.
Example 19 includes the subject matter of Example 17, wherein the foldable I/O port is further capable of forming a vertical placement inside the computing device relative to a horizontal plane of the chassis of the computing device in the closed configuration of the foldable I/O port.
Example 20 includes the subject matter of Example 11, wherein the foldable I/O port is further capable of being arranged on a side of a base of the computing device, and wherein at least a portion of the housing portion is capable of bending downwards below the base in the open configuration of the foldable I/O port.
Example 21 includes a method, comprising: pulling down a foldable input/output (I/O) port of a computing device to expose one or more I/O connectors of the foldable I/O port; wherein the foldable I/O port comprises: a connector board electrically connected to a circuit board of the computing device; the one or more I/O connectors arranged on the connector board, wherein the one or more I/O connectors are electrically connected with the connector board and capable of receiving one or more external connectors when the foldable I/O port is in an open configuration; and a housing portion, pivotably connected with a chassis of the computing device, wherein the housing portion is capable of housing the connector board and the one or more I/O connectors.
Example 22 includes the subject matter of Example 21, wherein the housing portion is a first housing portion, and the foldable I/O port further comprises: a second housing portion, capable of securing the one or more I/O connectors and the connector board to the first housing portion.
Example 23 includes the subject matter of Example 22, wherein the foldable I/O port further comprises: one or more fasteners, capable of securing the second housing portion to the first housing portion.
Example 24 includes the subject matter of Example 23, wherein the first housing portion further comprises: one or more receivers, capable of receiving the one or more fasteners.
Example 25 includes the subject matter of Example 21, wherein the foldable I/O port is further capable of: exposing the one or more I/O connectors in the open configuration of the foldable I/O port, wherein the foldable I/O port is in the open configuration in response to the foldable I/O port being pulled down.
Example 26 includes the subject matter of Example 21, further comprising: supporting, by the foldable I/O port, data transmission and/or power transmission between the computing device and the one or more external connectors when the one or more external connectors are plugged into the one or more I/O connectors in the open configuration of the foldable I/O port.
Example 27 includes the subject matter of Example 21, further comprising: folding up the foldable I/O port inside the computing device to form a continuous surface with a surface of the computing device, and wherein the foldable I/O port is in a closed configuration in response to the foldable I/O port being folded up inside the computing device.
Example 28 includes the subject matter of Example 27, further comprising: forming, by the foldable I/O port, a tilted placement inside the computing device relative to a horizontal plane of the chassis of the computing device in the closed configuration of the foldable I/O port.
Example 29 includes the subject matter of Example 27, further comprising: forming, by the foldable I/O port, a vertical placement inside the computing device relative to a horizontal plane of the chassis of the computing device in the closed configuration of the foldable I/O port.
Example 30 includes the subject matter of Example 21, wherein the foldable I/O port is further capable of being arranged on a side of a base of the computing device, and wherein at least a portion of the housing portion is capable of bending downwards below the base in the open configuration of the foldable I/O port.
Example 31 includes one or more non-transitory computer-readable media storing instructions which, when executed by one or more processors, cause the one or more processors to perform the method of any one of Examples 21 to 30.
Example 32 includes a computing apparatus comprising means for performing the method of any one of Examples 21 to 30.
Example 33 includes a computer program comprising instructions which, when executed by one or more processors, cause the one or more processors to perform the method of any one of Examples 21 to 30.
Example 34 includes a computer program comprising instructions which, when executed by one or more processors, cause the one or more processors to perform the method of any one of Examples 21 to 30.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A foldable input/output (I/O) port of a computing device, comprising:
a connector board, electrically connected with a circuit board of the computing device;
one or more I/O connectors, arranged on the connector board, wherein the one or more I/O connectors are electrically connected with the connector board and capable of receiving one or more external connectors when the foldable I/O port is in an open configuration; and
a housing portion, pivotably connected with a chassis of the computing device, wherein the housing portion is capable of housing the connector board and the one or more I/O connectors.

2. The foldable I/O port of claim 1, wherein the housing portion is a first housing portion, and the foldable I/O port further comprises:
a second housing portion, capable of securing the one or more I/O connectors and the connector board to the first housing portion.

3. The foldable I/O port of claim 2, further comprising:
one or more fasteners, capable of securing the second housing portion to the first housing portion.

4. The foldable I/O port of claim 3, wherein the first housing portion further comprises:
one or more receivers, capable of receiving the one or more fasteners.

5. The foldable I/O port of claim 1, further capable of:
exposing the one or more I/O connectors in the open configuration of the foldable I/O port, wherein the foldable I/O port is in the open configuration in response to the foldable I/O port being pulled down.

6. The foldable I/O port of claim 1, further capable of:
supporting data transmission and/or power transmission between the computing device and the one or more external connectors when the one or more external connectors are plugged into the one or more I/O connectors in the open configuration of the foldable I/O port.

7. The foldable I/O port of claim 1, wherein the housing portion is further capable of forming a continuous surface with a surface of the computing device when the foldable I/O port is in a closed configuration, and wherein the foldable I/O port is in the closed configuration in response to the foldable I/O port being folded up inside the computing device.

8. The foldable I/O port of claim 7, further capable of forming a tilted placement inside the computing device relative to a horizontal plane of the chassis of the computing device in the closed configuration of the foldable I/O port.

9. The foldable I/O port of claim 7, further capable of forming a vertical placement inside the computing device relative to a horizontal plane of the chassis of the computing device in the closed configuration of the foldable I/O port.

10. The foldable I/O port of claim 1, further capable of being arranged on a side of a base of the computing device, wherein at least a portion of the housing portion is capable of bending downwards below the base in the open configuration of the foldable I/O port.

11. A computing device, comprising:
a chassis; and
a foldable input/output (I/O) port, wherein the foldable I/O port comprises:
a connector board, electrically connected with a circuit board of the computing device;
one or more I/O connectors, arranged on the connector board, wherein the one or more I/O connectors are electrically connected with the connector board and capable of receiving one or more external connectors when the foldable I/O port is in an open configuration; and
a housing portion, pivotably connected with the chassis of the computing device, wherein the housing portion is capable of housing the connector board and the one or more I/O connectors.

12. The computing device of claim 11, wherein the housing portion is a first housing portion, and the foldable I/O port further comprises:
a second housing portion, capable of securing the one or more I/O connectors and the connector board to the first housing portion.

13. The computing device of claim 12, wherein the foldable I/O port further comprises:
one or more fasteners, capable of securing the second housing portion to the first housing portion.

14. The computing device of claim 13, wherein the first housing portion further comprises:
one or more receivers, capable of receiving the one or more fasteners.

15. The computing device of claim 11, wherein the foldable I/O port is further capable of:
exposing the one or more I/O connectors in the open configuration of the foldable I/O port, wherein the foldable I/O port is in the open configuration in response to the foldable I/O port being pulled down.

16. The computing device of claim 11, wherein the foldable I/O port is further capable of:
supporting data transmission and/or power transmission between the computing device and the one or more external connectors when the one or more external connectors are plugged into the one or more I/O connectors in the open configuration of the foldable I/O port.

17. The computing device of claim 11, wherein the housing portion is further capable of forming a continuous surface with a surface of the computing device when the foldable I/O port is in a closed configuration, and wherein the foldable I/O port is in the closed configuration in response to the foldable I/O port being folded up inside the computing device.

18. The computing device of claim 17, wherein the foldable I/O port is further capable of forming a tilted placement inside the computing device relative to a horizontal plane of the chassis in the closed configuration of the foldable I/O port.

19. The computing device of claim 17, wherein the foldable I/O port is further capable of forming a vertical placement inside the computing device relative to a horizontal plane of the chassis of the computing device in the closed configuration of the foldable I/O port.

20. The computing device of claim 11, wherein the foldable I/O port is further capable of being arranged on a side of a base of the computing device, and wherein at least a portion of the housing portion is capable of bending downwards below the base in the open configuration of the foldable I/O port.
